(19) United States
(12) Patent Application Publication
(10) Pub. No.: US 2020/0040875 A1
(43) Pub. Date: Feb. 6, 2020

(54) SYSTEM UTILIZING BUOYANCY TO PRODUCE ELECTRICITY

(71) Applicant: Thomas B. Chase, Winnsboro, SC (US)

(72) Inventor: Thomas B. Chase, Winnsboro, SC (US)

(21) Appl. No.: 16/533,113

(22) Filed: Aug. 6, 2019

Related U.S. Application Data
(60) Provisional application No. 62/714,918, filed on Aug. 6, 2018.

(51) Int. Cl. F03G 7/00

(52) U.S. Cl. CPC F03G 7/00

(57) ABSTRACT

A buoyancy based system for generating electricity includes a housing having a first container and a second container. The first container contains a first fluid. The second container contains a second fluid. The first fluid has a density greater than a density of the second fluid. A belt is rotatably mounted within the first container for engaging at least one buoyant body when an at least one buoyant body is disposed within the first container. The belt is rotated by the at least one buoyant body when engaging the at least one buoyant body. A driveshaft is operatively coupled to the belt so that rotation of the belt rotates the driveshaft.

### BACKGROUND OF THE INVENTION

The present invention is directed to a system utilizing rotational motion to create electricity; and more particularly, to a system having a rotatable belt disposed within a fluid having a first density and engaging a body having a second density sufficiently less than the first density to be sufficiently buoyant within the fluid to rotate the belt when engaged by the belt; the rotation of the belt driving an electrical generator.

According to many scientists, carbon levels in the atmosphere have been increasing steadily since 1959 when the first measurements were activated concerning carbon in the earth's atmosphere. The primary cause of the carbon level rise is the creation of energy by the use of fossil fuels. There are approximately eleven primary forms of energy existing today ranging from severely climate damaging to renewable: coal, oil, gas, shale, nuclear, hydroelectric, thermal, steam, wave action, wind and solar. Each has its advantages, particularly the renewable energy sources.

Each of these energy sources have advantages relative to each other, however they often suffer from the disadvantage that if they are not extremely damaging, such as coal, they are an intermittent unreliable source of energy; such as solar, wind, and wave action. Sunny days, sufficiently powerful winds, and even wave action cannot be relied upon for consistent predictable energy production. Additionally, the size of the facility to create carbon burning energy plants to produce sufficient electricity, and the location of optimal wind and solar sources, prevents the energy production source being near the point of consumption of the electricity. As a result large unsightly, continuously maintained power grids are required to transport the electricity to the consumer.

Additionally, although the plausibility of solar energy as a local off grid power source has been well-documented, solar implementation is very expensive, and costs aren't likely to decline enough to make it affordable to the majority of the world's population, and most importantly it is regional weather dependent. Wind generation of electricity is dependent on an erratic premise: that the wind will consistently and predictably blow. Additionally, wind turbines are a distractive eyesore to background scenery. Hydroelectric systems, although Carbon friendly, create environmental headaches such as flooding of needed land and can be destructive to fish and fowl habitats. Another consideration is that the generation of power from utility companies competes with the need for land for agricultural and building purposes. And telephone poles, with their myriad wires, are, like windmills, an esthetic problem. Additionally, when power is lost as it travels to homes and businesses; it may lead to frustrating blackouts, handicapping daily activities of hundreds or thousands of people.

Accordingly, a system for generating electricity which overcomes the shortcomings of the prior art by being reliable, climate and weather independent and capable of being deployed locally is desired.

### SUMMARY OF THE INVENTION

A buoyancy based system for generating electricity includes a housing. The housing has a first container and a second container. The first container contains a first fluid. The second container contains a second fluid. The first fluid has a density greater than a density of the second fluid. At least one body has a density less than the first fluid and greater than the second fluid. A belt is rotatably mounted within the first container for engaging the at least one body when the at least one body is disposed within the first container. The at least one body exhibiting buoyancy when disposed in the first fluid sufficient to rotate the rotatable belt when the at least one body is engaged by the rotatable belt. The belt is operatively coupled to a driveshaft such that rotation of the belt rotates the driveshaft. The driveshaft is coupled to an electrical generator.

During operation, the buoyant body is injected into the first container at the beginning of a travel path. The travel path is substantially in parallel with the length (long axis) of the rotatable belt. The rotatable belt engages the buoyant object at the beginning of the travel path. The body is sufficiently buoyant to drive the belt as the body traverses the travel path. At the top of the travel path, the belt transfers the body to the second container. The density of the body is less than the density of the fluid in the second container and falls within the second container to return to the beginning of the travel path.

### BRIEF DESCRIPTION OF THE DRAWINGS

The present disclosure will be better understood by reading the written description with reference to the accompanying drawing figure in which like reference numerals denotes similar structure and referred to like elements throughout in which:

FIG. 1 is a front plan view of a system for using buoyancy to produce electricity constructed in accordance with the invention;

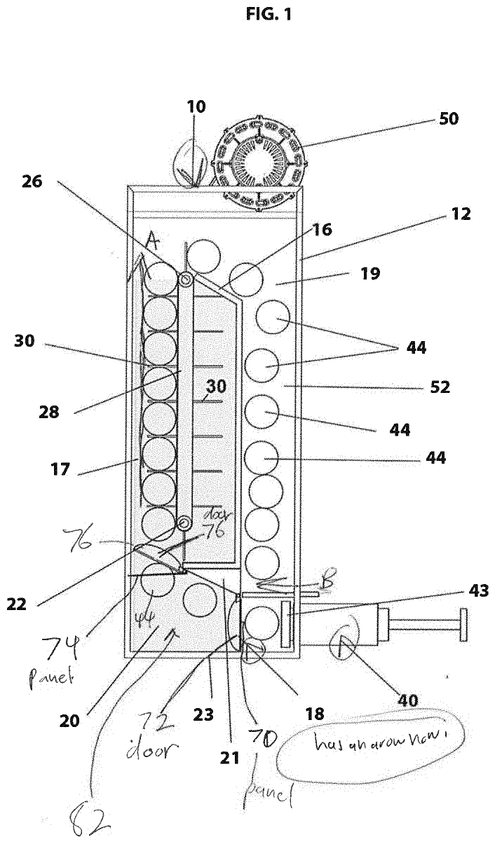

FIG. 2 is a left perspective view thereof;

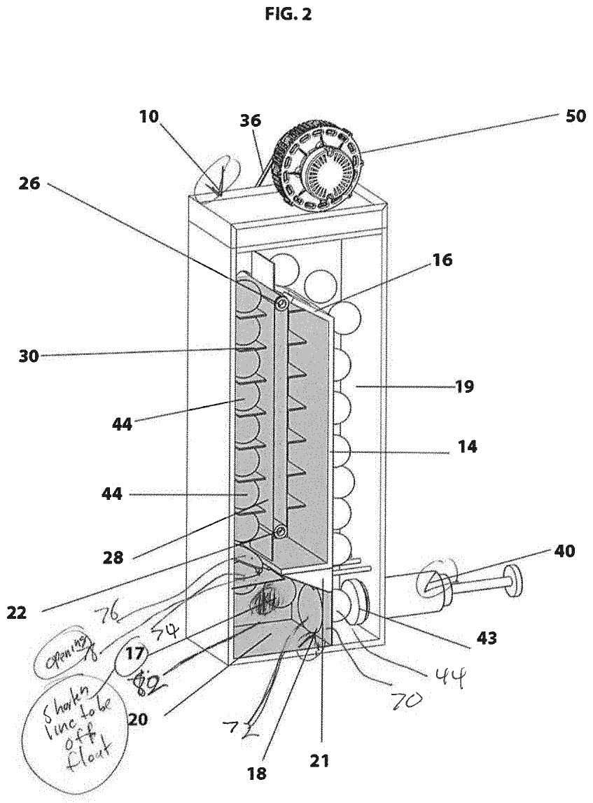

FIG. 3 is a right perspective view thereof; and

FIG. 4 is a rear right perspective view thereof.

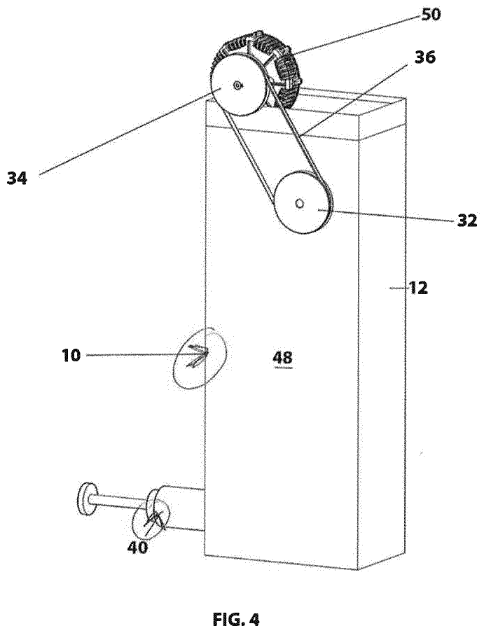

### DETAILED DESCRIPTION OF THE PREFERRED EMBODIMENT

A system 10 for using buoyancy to produce electricity includes a housing 12. A divider 14 is disposed within the housing 12 to separate housing 12 into a first container 17 and a second container 19. Divider 14 includes an angled portion 16 at a top of divider 14. A gap h exists between angled portion 16 and housing 12 providing communication between first container and second container 19. A valve assembly 18 is disposed between a floor 23 of housing 10 and divider 14, i.e. at the bottom of divider 12 to prevent fluid communication between first container 17 and second container 19 while allowing objects to travel between first container 17 and second container 19.

A driveshaft 26 is rotatably mounted to a rear wall 48 of housing 12 and extends within the first container 17. And idler shaft 22 is mounted on rear wall 40 of housing 12 and extends into contain first container 17 at a position spaced from driveshaft 26. A belt 28 is mounted within first container 17, about idler shaft 22 and driveshaft 26. Rotation of belt 28 about driveshaft 26 and idler shaft 22 rotates driveshaft 26. At least one vane 30, but preferably pluralities of vanes 30, extend from belt 28 at spaced intervals.

Driveshaft 26 extends through housing 12, preferably through rear wall 48. A drive wheel 32 is mounted to that portion of driveshaft 26 extending out from housing 12. A generator 50 is operatively coupled to drive wheel 32 by a drive pulley 34 and a drive belt 36. In a preferred embodiment, generator 50 may be mounted on housing 12 to provide a compact form factor for system 10. Rotation of driveshaft 26 rotates drive wheel 32 which in turn rotates drive pulley 34 causing generator 50 to generate electricity as known in the art from rotary coil generators.

A first fluid 20 is contained within first container 17. A second fluid 52 is contained by second container 19. The density of the first fluid 20 is greater than the density of second fluid 52. In a preferred embodiment, first fluid 20 is a liquid and second fluid 52 is a gas. When first fluid 20 is a liquid, any fluid material such as, alcohol, mercury, acetone, anti-freeze, i.e. any liquid, but preferably water, because of its lack of toxicity and ready availability, may potentially suffice.

Fluid 52 may be any fluid, including other liquids, having a density less than that of first fluid 20. However, for ease of use, and maintenance, second fluid 52 is preferably a gas, and preferably air. Because the primary criteria for the atmosphere within second container 19 is that it have a density less than that of the fluid contained in first container 17, second fluid 52, may in fact be the absence of fluid; a vacuum.

Floats 44 are objects having a density sufficiently greater than the density of second fluid 52 so as to sink relative to second fluid 52 and sufficiently less than the density of first fluid 20 to be positively buoyant relative to first fluid 20. Floats 44 are sufficiently buoyant so that when engaging a vane 30 of rotatable belt 28, the force of buoyant object 44 pushing on vane 30 causes rotation of rotatable belt 28. It should be noted, that in a preferred embodiment, each float 44 of the plurality of floats contained in the system 10, is sufficiently buoyant to cause rotation of belt 28 as float 44 ascends within container 17. However, as can be seen, system 10 also operates to produce electricity if two or more floats 44 having a lesser buoyancy, acting together provide a sufficient cumulative force to drive belt 28 to rotate within first container 17.

Buoyant objects, floats, 44 may be any geometric shape: such as spheres, rectangles, cubes, dodecahedrons or even cylinders by way of non-limiting example. The objects 44 are preferably solid hollow objects filled with a low density fluid, preferably gas, and more preferably filled with air, or any other gas having a density less than first fluid 20, but significantly less than second fluid 52. Buoyant objects 44 may even be solid as long as they have the ability to displace the liquid in which they may reside; Styrofoam balls in water by way of non-limiting example. All that is required is that there may be sized to be disposed between adjacent vanes 30 when engaging a single vane 30; while having the necessary buoyancy described above.

It should be noted that the vanes 30 extending from belt 28 may be formed as a solid object, or may be porous, offering less drag, as each vane 30 moves through first liquid 20. Each vane 30 extends from belt 28 into a pathway of ascension A sufficient distance to become engaged by an ascending float 44 as each float 44 rises through first liquid 20.

A plunger assembly 40 is disposed at least partially within second container 19 in facing relationship with the valve assembly 18. In a non-limiting, exemplary embodiment, valve assembly 18 includes a first panel 70 disposed between first container 17 and second container 19. An opening (not shown) is formed within panel 70 in facing relationship with plunger assembly 40. A hinged door 72 is rotatably affixed relative to panel 70 and covers the opening. The opening having a diameter sized to be sufficiently greater than the diameter of the floating object 44 to allow passage, but not sufficiently greater to allow significant water to pass through the opening when first door 72 is deflected from the opening as the buoyant floating object 44 passes through opening 78. The opening may even be covered with a deflectable film to prevent fluid 20 from escaping first container 17 as buoyant object 44 passes therethrough.

A second panel 74 is disposed within first container 17 to seal a valve chamber 82 formed by second panel 74 and first panel 70 within first container 17. As with first panel 70, second panel 74, is formed with an opening 78 having a diameter sized to be sufficiently greater than the diameter of the floating object 44, but not sufficiently greater to allow significant water to pass through opening 78 when a second door 76, which covers opening 78, is deflected from opening 78 as the buoyant floating object 44 passes through opening 78. Opening 78 may also be covered with a deflectable film to further prevent fluid 20 from passing through opening 70 as float 44 passes through opening 78. The film works much like a diaphragm.

In a preferred embodiment, opening 78 is open in asymmetrical timing with the opening within first panel 70 being open. In this way, fluid contained within valve chamber 82 is contained within first container 17, and valve chamber 82 acts as a controlling buffer between first container 17 and second container 19; controlling the flow of fluid 20 from container 17. Furthermore, the weight of fluid 20 within first container 17 pushes against respective door 72, 76 biasing the respective door 72, 76 to be closed tightly about the respective openings. By providing watertight seals utilizing panels 70, 74, the weight of the water acting on the opening within first panel 70 is only the weight of the water column within the valve chamber 82, not the weight of the entire column within first container 17. This reduces the force to be overcome by any deflectable film over the opening within panel 70 and the force required to insert a float 44 into valve chamber 82.

Plunger assembly 40 includes a plunger 43 which is periodically activated to move in a direction B to engage a buoyant object, float, 44, and push float 44 from second container 19 through valve 18 into first container 17. Divider 14 has an angled surface 21 within first container 17 at valve 18 to guide the now buoyant float 44 into position adjacent rotatable belt 28 to engage the next vane 30 in rotation at the beginning of ascension path A, as object 44 ascends form angled surface 21.

During operation, valve assembly 18 permits objects 44 to pass from second container 19 to first container 17 while preventing first fluid 20 from entering second container 19. In a preferred embodiment, valve assembly 18 selectively allows objects 44 under force from plunger assembly 40 to pass from the second container 19 to the first container 17, but not in the reverse direction.

During operation buoyant objects, one or more floats 44, are initially disposed in second container 19. Because objects 44 are not buoyant in the fluid contained in content second container 19, they move under the influence of gravity to floor 23 of housing 12 where at least one float 44 is positioned between plunger assembly 40 and valve assembly 18. First container 17 is filled with a fluid such as water. Drive wheel 32 is locked in position. The purpose of the lock is to ensure that as fluid 20 fills first container 17, and any buoyant objects 40 inadvertently come in contact with the vanes 30 or the force of rising fluid 20 comes in contact with the vane 30 belt 28 will not rotate.

To begin operation, drive wheel 32 is unlocked. Any floats 40, within first container 17 which are now positively buoyant, engage vanes 30 and rotate belt 28. Assuming no floats 44 are disposed in first container 17 at the commencement of operation, or, during operation when there are floats ascending in container 17, the float disposed in the pathway of plunger 43 is contacted by plunger 43 and forced through valve assembly 18 as plunger 43 moves in the direction of arrow B.

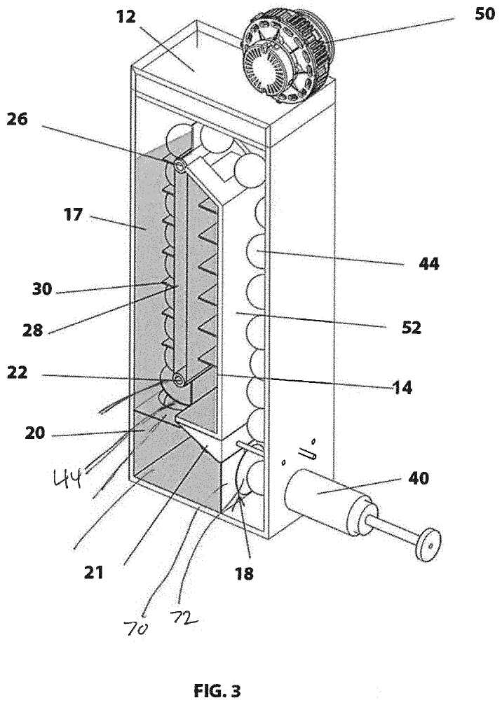

As the engaged float 44 passes through valve assembly 18, it transforms from a buoyancy negative object to a buoyancy positive object and ascends to come into contact with angled surface 21. The buoyancy of float 44 as it engages angled surface 21 will cause buoyant object, float 44 to rise along ascension path A within first container 17. (FIG.3) Angled surface 21 will guide float 44 towards a position within container 17 to engage a vane 30 as it rotates into position as belt 28 rotates during the ascension of float 44. Float 44 may be us assisted in its movement along angled surface 21 if engaged by a second, following float 44 passing through valve assembly 18 forcing the leading float 44 along angled surface 21 as trailing float 44 is pushed by plunger 43 as plunger 43 travels in the direction of arrow B.

Once float 44 engages a vane 30 as a result of the buoyancy of float 44, it provides a net upward force against vane 30 as it engages vane 30 in the direction of ascension path A. Each float 44 applies this force to a respective vane 30 along the entire pathway. There is sufficient force provided by floats 44 so that when drive wheel 32 is in the unlocked position, i.e., freeing driveshaft 26 to rotate, in turn freeing belt 28 to rotate, belt 28 is constantly rotating. Therefore, as a float 40 becomes adjacent gap h, there is sufficient force for vane 30 to lift and deliver float 44 through gap h. At gap h, float 44 goes from buoyancy positive to buoyancy negative as it enters the second container 19 having low density fluid 52. As a result, gravity causes float 44 located at gap h to roll along angled portion 16 into a position to eventually travel to floor 23 to again be in the pathway of plunger 43, repeating the cycle.

Furthermore, because a plurality of floats 44 are engaging vanes 30 at any given time, once vane 30 rotates to gap h, vane 30 then rotates back into first container 19 to return to the beginning of ascension path A to being engaged by a respective at ascending float 44.

As belt 28 rotates, belt 28, which engages driveshaft 26, rotates driveshaft 26. In turn driveshaft 26 rotates drive wheel 32 which rotates drive pulley 34. Drive pulley 34, operatively connected to generator 50 drives generator 50 to convert the rotational energy of drive pulley 34 to electricity which may be used locally to apparatus 10. It should be noted that drive shaft 26 may also drive other mechanical devices to convert rotational energy into other types of work, such as a mechanical device utilizing gears and pulleys.

The total electrical energy produced by apparatus 10 will vary as a function of the length of belt 28 and the relative size and buoyancy of floating objects 40; which in turn are a function of the density of the first fluid 20, the second fluid 52, and floats 44. However, in one simple example utilizing water as the first fluid, areas the second fluid, an error filled buoyant devices 40, in a dragless/frictionless system, system 10 can theoretically produce the equivalent of 3400.2 watts of continuous electric power every second.

One Mechanical Horsepower is equal to 33,000 foot-pounds generated in one minute of time. That mechanical power is equal to 756 watts of electrical horsepower. Therefore, a container containing one cubic foot of air has the potential to produce approximately 45% of one horsepower or 0.585 horsepower per month.

One minute contains 60 seconds. One cubic foot of air will travel 240 ascendant feet in 60 seconds. (4 feet per second). As the cubic foot of air generating a force of 62.4 pounds rises, in one minute, it will produce 14,880 foot-pounds of potential energy. (14,880 divided by 33,000 foot-pounds equals approximately 0.45). (One horsepower is equal to 756 watts; 45% of one horsepower is 340.2 watts). One horsepower can produce 1.3 kilowatts per month at 100% efficiency. Thus, 45% of one horsepower can produce 0.585 horsepower per month. Therefore, ten buoyant objects 40 can produce 5.85 horsepower per month. As seen from above, 5.85 horsepower can produce 50,850 watts per month equal to 50.85 kilowatts per month. Thus, a cubic foot of air, harnessed properly, can produce almost ½ of a unit of horsepower or 340.2 watts of power per second or 20,412 watts per hour,

One kilowatt of power equals approximately 1.34 horsepower. If ten one cubic foot containers of air were simultaneously used as buoyant objects 40 in system 10, by converting their potential energy into horsepower or watts, system 10 could produce the equivalent of 3400.2 watts of continuous electric power every second. By way of comparison, the average home uses 9800 KW hours per month.

By constructing a system as described above, utilizing air and water as the relative fluids, an inexpensive, sustainable stand-alone device for producing electricity is provided. The system is also easy to maintain, having little maintenance apart from occasionally topping off the water, and replacing a belt exhibiting wear and tear. Furthermore, the system can be easily positioned and maintained locally, where the electricity is consumed, eliminating the need for a grid-like transportation system.

Thus, there have been shown, described and pointed out novel features of the present invention as applied to preferred embodiments thereof, it will be understood that various submissions and substitutions and changes in the form in detail are contemplated to the disclosed invention which may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of the invention which, is a matter of language, might be said to fall there between.

What is claimed is:

1. A buoyancy based system for generating electricity comprises:
a housing having a first container and a second container, the first container for containing a first fluid, the second container for containing a second fluid, the first fluid having a density greater than a density of the second fluid;
a belt rotatably mounted within the first container for engaging at least one buoyant body when an at least one buoyant body is disposed within the first container, the belt being rotated by the at least one buoyant body when engaging the at least one buoyant body;
a driveshaft operatively coupled to the belt so that rotation of the belt rotates the driveshaft.

2. The buoyancy based system for generating electricity of claim 1, further comprising a valve disposed between the first container and the second container, the valve being positioned to prevent the first fluid from passing from the first container to the second container and allowing the at least one buoyant body to be passed from the second container to the first container.

3. The buoyancy based system for generating electricity of claim 1, further comprising a generator, the generator being operatively coupled to the driveshaft and generating electricity in response to rotation of the driveshaft.

4. The buoyancy based system for generating electricity of claim 3, wherein the generator is mounted on the housing.

5. The buoyancy based system for generating electricity of claim 1, wherein the first fluid is a liquid and the second fluid is a gas.

6. The buoyancy based system for generating electricity of claim 1, further comprising at least one vane extending from the belt to engage at least one buoyant body when an at least one buoyant body is disposed within the first container.

7. The buoyancy based system for generating electricity of claim 2, further comprising a plunger assembly, at least partially disposed within the second container, the plunger assembly having a plunger for moving a buoyant object through the valve.

8. The buoyancy based system for generating electricity of claim 1, further comprising a guide disposed within said first container for guiding a buoyant object from the valve to the rotatable belt.

9. The buoyancy based system for generating electricity of claim 1, further comprising a gap formed within the housing, between the first container and the second container, at an end of an ascension path traveled within the first container by the at least one buoyant object of the and being, the gap being sized to enable the at least one buoyant object to move from the first container to the second container.
